(19) United States
(12) Patent Application Publication
(10) Pub. No.: US 2019/0205521 A1
(43) Pub. Date: Jul. 4, 2019

(54) USER AUTHENTICATION INTEGRATION DEVICE AND METHOD, AND RECORDING MEDIUM

(71) Applicant: NEC CORPORATION, Tokyo (JP)

(72) Inventor: Shota MORISHITA, Tokyo (JP)

(73) Assignee: NEC CORPORATION, Tokyo (JP)

(21) Appl. No.: 16/311,371

(22) PCT Filed: Jun. 19, 2017
(86) PCT No.: PCT/JP2017/022438

§ 371 Date: Dec. 19, 2018

(30) Foreign Application Priority Data
Jun. 20, 2016 (JP) 2016-121772

(51) Int. Cl. G06F 21/41; G06F 21/45; G06F 21/35; H04W 12/06

(52) U.S. Cl. CPC G06F 21/41; H04W 12/06; G06F 21/35; G06F 21/45

(57) ABSTRACT

To provide a user authentication integration device that facilitates use of a plurality of systems that each require user authentication without setting new user authentication information. The user authentication integration device includes: user authentication information management means that stores and manages, for each user, user authentication information for using each of one or more available systems; user authentication means that, when receiving user authentication information for an arbitrary authentication target system among the systems from a terminal, performs user authentication relating to the authentication target system with the user authentication information; target system acquisition means that, when the user authentication is successful, acquires information representing a target system among the systems; and relay means that relays communication between the terminal and the target system using user authentication information for the target system stored in the user authentication information management means with regard to a user authenticated.

### TECHNICAL FIELD

The present invention relates to a technique for managing a user authentication request for a plurality of systems.

### BACKGROUND ART

In general, when a user uses a plurality of systems, the user needs to request authentication for each system using user authentication information that is set individually for each system. It is a troublesome work for a user to request the authentication using user authentication information that is individually set for each system the user wants to use. Accordingly, a technique for managing a user authentication request for a plurality of systems is known.

For example, in a related technique described in PTL 1, a management device stores, for each management target user, IDs and passwords associated with systems that the user is authorized to use. A terminal authenticates a user with an ID and password for access. The terminal, then, acquires the ID and password associated with a system specified by the authenticated user from the management device and transmits to the system. In this way, the user can use a plurality of systems only by using the ID and password for access.

### CITATION LIST

### Patent Literature

PTL 1: Japanese Unexamined Patent Publication No. 2012-190077

### SUMMARY OF INVENTION

### Technical Problem

However, the related technique described in PTL 1 has the following problem:

With this related technique, a user needs to set an extra new ID and password for the access, besides user authentication information that has been set for each of a plurality of systems in order to allow the user to use the plurality of systems with a single piece of user authentication information. It is not convenient for a user to be required the new user authentication information in such a way.

The present invention has been contrived to solve the above-described problem. That is, the objective of the present invention is to provide a user authentication integration device and the like that facilitates use of a plurality of systems that each require user authentication without setting new user authentication information.

### Solution to Problem

A user authentication integration device of the present invention includes:
user authentication information management means that stores and manages, for each user, user authentication information for using each of one or more available systems;
user authentication means that, when receiving user authentication information for an arbitrary authentication target system among the systems from a terminal, performs user authentication relating to the authentication target system, using the received user authentication information;
target system acquisition means that, when the user authentication is successful, acquires, from the terminal, information representing a target system among the systems; and
relay means that relays communication between the terminal and the target system using user authentication information for the target system stored in the user authentication information management means with regard to a user authenticated by the user authentication means.

A method of the present invention uses user authentication information management means that stores and manages, for each user, user authentication information for using each of one or more available systems. The method includes: by a computer device,
when receiving, from a terminal, user authentication information for an arbitrary authentication target system among the systems, performing user authentication relating to the authentication target system using received user authentication information;
when the user authentication is successful, acquiring, from the terminal, information representing a target system among the systems; and
relaying communication between the terminal and the target system using user authentication information for the target system stored in the user authentication information management means with regard to an authenticated user.

A recording medium for storing a program uses user authentication information management means that stores and manages, for each user, user authentication information for using each of one or more available systems. The program causes a computer device to perform:
a user authentication step that, when receiving user authentication information for an arbitrary authentication target system among the systems from a terminal, performs user authentication relating to the authentication target system using the received user authentication information;
a target system acquisition step that, when the user authentication is successful, acquires, from the terminal, information representing a target system among the systems; and
a relay step that relays communication between the terminal and the target system using user authentication information for the target system stored in the user authentication information management means with regard to a user authenticated at the user authentication step. The program can be stored in a storage medium.

### Advantageous Effects of Invention

The present invention can provide a user authentication integration device and the like that further facilitates use of a plurality of systems that each require user authentication without setting new user authentication information.

### BRIEF DESCRIPTION OF DRAWINGS

FIG. 1 is a block view illustrating a configuration of a user authentication integration device according to a first example embodiment of the present invention;

FIG. 2 is a diagram illustrating an example of a hardware configuration of the user authentication integration device according to the first example embodiment of the present invention;

FIG. 3 is a flowchart illustrating the operation of the user authentication integration device according to the first example embodiment of the present invention;

FIG. 4 is a sequence diagram illustrating an example of the flow of operation when a terminal uses a system in the first example embodiment of the present invention;

FIG. 5 is a block view illustrating a configuration of a user authentication integration device according to a second example embodiment of the present invention;

FIG. 6 is a flowchart illustrating the operation of the user authentication integration device according to the second example embodiment of the present invention;

FIG. 7 is a sequence diagram illustrating an example of the flow of operation when a terminal uses systems in the second example embodiment of the present invention;

FIG. 8 is a block view illustrating a configuration of a user authentication integration device according to a third example embodiment of the present invention;

FIG. 9 is a flowchart illustrating the operation of the user authentication integration device according to the third example embodiment of the present invention; and

FIG. 10 is a sequence diagram illustrating an example of the flow of operation when a terminal uses systems in the third example embodiment of the present invention.

### EXAMPLE EMBODIMENT

The following will describe the details of the example embodiments of the present invention with reference to the drawings.

### First Example Embodiment

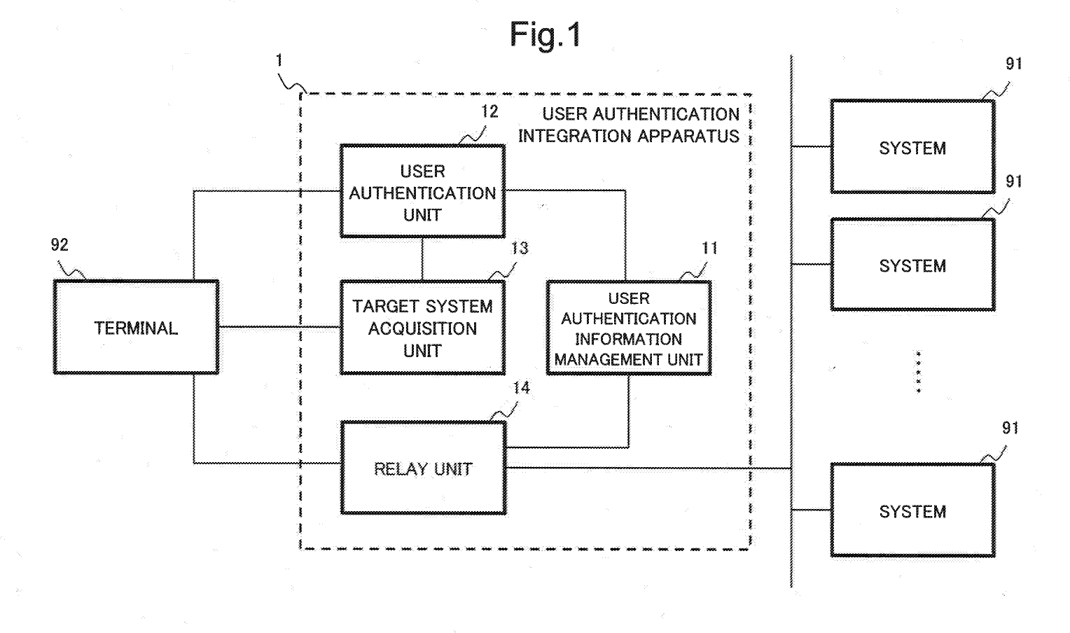

FIG. 1 illustrates a functional block view illustrating a configuration of a user authentication integration device 1 according to a first example embodiment of the present invention. In FIG. 1, the user authentication integration device 1 includes: a user authentication information management unit 11; a user authentication unit 12; a target system acquisition unit 13; and a relay unit 14.

The user authentication integration device 1 is communicatively connected to each of one or more systems 91 through a network. Further, the user authentication integration device 1 is communicatively connected to a terminal 92 through a network. Note that, while FIG. 1 illustrates three systems 91 and one terminal 92, the numbers of the systems 91 and terminals 92 that are connected to the user authentication integration device 1 are not restricted to these numbers.

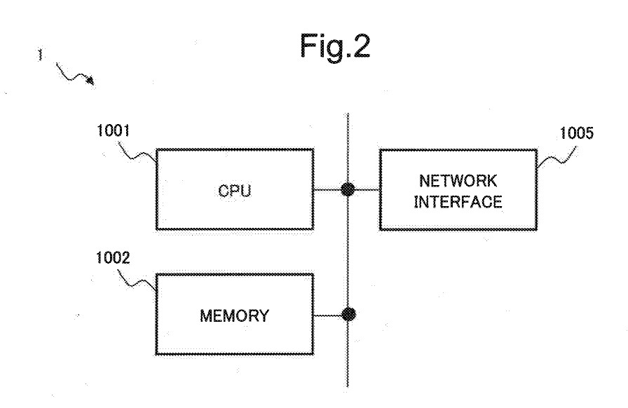

The user authentication integration device 1 is configurable with hardware components as illustrated in FIG. 2. In FIG. 2, the user authentication integration device 1 includes: a central processing unit (CPU) 1001; a memory 1002, and a network interface 1005. The memory 1002 is configured with a random access memory (RAM), a read only memory (ROM), or an auxiliary storage device (e.g., a hard disk). The network interface 1005 is an interface that is connected to a network configured with the Internet, a local area network (LAN), a public line network, a wireless communication network, or a combination of any of them. In this case, the functional blocks of the user authentication integration device 1 include the network interface 1005 and the CPU 1001 that reads and executes information and a computer program stored in the memory 1002. Note that the hardware configuration of the user authentication integration device 1 and the functional blocks thereof is not restricted to the above-described configuration.

The system 91 is a device that provides services. In the system 91, user authentication information is set for each user. Further, the system 91 is configured to provide services to a user who has succeeded in user authentication.

The terminal 92 is a device that is used by a user who desires to use the system 91. The terminal 92 acquires user authentication information through an input device or the like. Further, the terminal 92 transmits the acquired user authentication information to the system 91. Note that the user authentication information that is transmitted from the terminal 92 to the system 91 is received by the user authentication integration device 1 that relays communications between the terminal 92 and the system 91.

Next, the details of each functional block of the user authentication integration device 1 will be described.

The user authentication information management unit 11 stores and manages, for each user, user authentication information for using each of the one or more available systems 91. The user authentication information may be, for example, an ID and a password. The management refers to processing such as inquiry, registration, update, and deletion of user authentication information.

The user authentication unit 12 receives user authentication information for an arbitrary authentication target system 91 from the terminal 92. Then, the user authentication unit 12 performs user authentication using the received user authentication information. For example, the user authentication unit 12 may perform user authentication by collating the received user authentication information with information stored in association with the authentication target system 91 in the user authentication information management unit 11. In this case, when the received user authentication information is stored in association with the authentication target system (a system selected and requested for authentication by the user) 91 in the user authentication information management unit 11, the user authentication unit 12 may determine that the user authentication is successful for the user associated with the user authentication information.

When receiving a notification of successful user authentication from the user authentication unit 12, the target system acquisition unit 13 acquires information representing a target system (a system selected and desired to be used by the user) 91 from the terminal 92. For example, the target system acquisition unit 13 may transmit information for enabling the available systems 91 to be selected to the terminal 92. In this case, the target system acquisition unit 13 may acquire information representing a system 91 that was input through the input device or the like of the terminal 92 as information representing the target system 91 from the terminal 92. Note that the authentication target system 91 and the target system 91 may be the same system or different systems. For example, authentication may be performed with an ID of system A, and, based on the successful authentication result, the system B may be used.

The relay unit 14 acquires user authentication information for the target system 91, stored in the user authentication information management unit 11, with regard to the user authorized by the user authentication unit 12. Then, the relay unit 14 relays communication between the terminal 92 and the target system 91 using the acquired user authentication information for the target system 91. For example, the relay unit 14 may relay communication by adding information representing user authentication information, successful authentication, or the like, as necessary, to information to be transmitted and received between the terminal 92 and the target system 91.

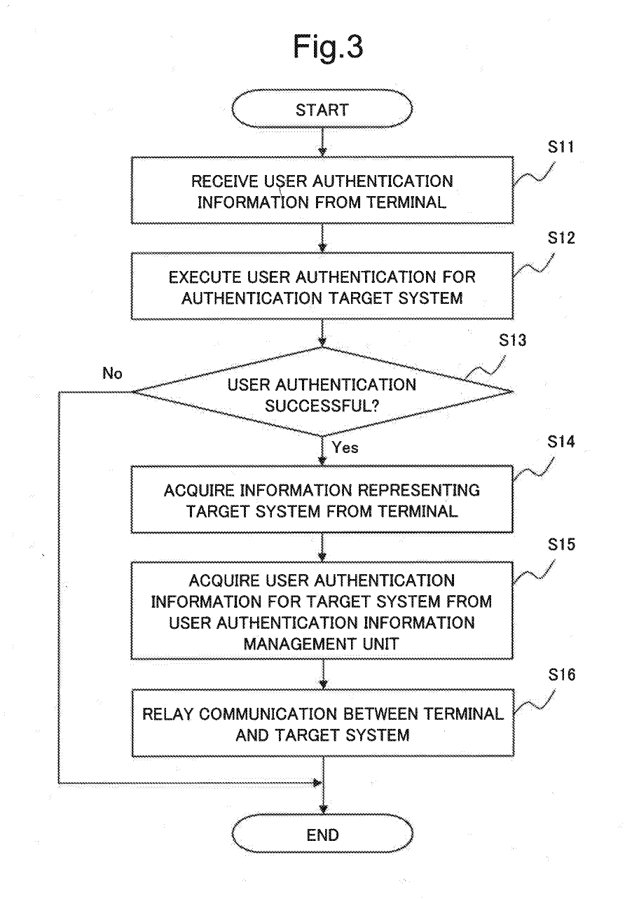

The operation of the user authentication integration device 1 with the above-described configuration will be described with reference to the drawings. First of all, the operation of the user authentication integration device 1 is illustrated in FIG. 3.

In FIG. 3, the user authentication unit 12, first, receives user authentication information for an arbitrary authentication target system 91 from the terminal 92 (step S11). For example, the user authentication unit 12 may receive information that can identify the authentication target system 91, as well as, the user authentication information.

Next, the user authentication unit 12 collates the user authentication information received at step S11 with information stored in the user authentication information management unit 11 and performs user authentication relating to the authentication target system 91 (step S12).

When the user authentication is not successful (No at step S13), the user authentication integration device 1 ends the processing.

Whereas, if the user authentication is successful (Yes at step S13), the target system acquisition unit 13 acquires information representing a target system 91 by requesting it to the terminal 92 (step S14). Note that the authentication target system 91 and the target system 91 may be the same system or different systems.

Next, with regard to the user authenticated by the user authentication at step S12, the relay unit 14 acquires user authentication information for the target system 91 from the user authentication information management unit 11 (step S15).

Then, the relay unit 14 relays communication between the target system 91 and the terminal 92 using the acquired user authentication information (step S16).

The operation of the user authentication integration device 1 has been described.

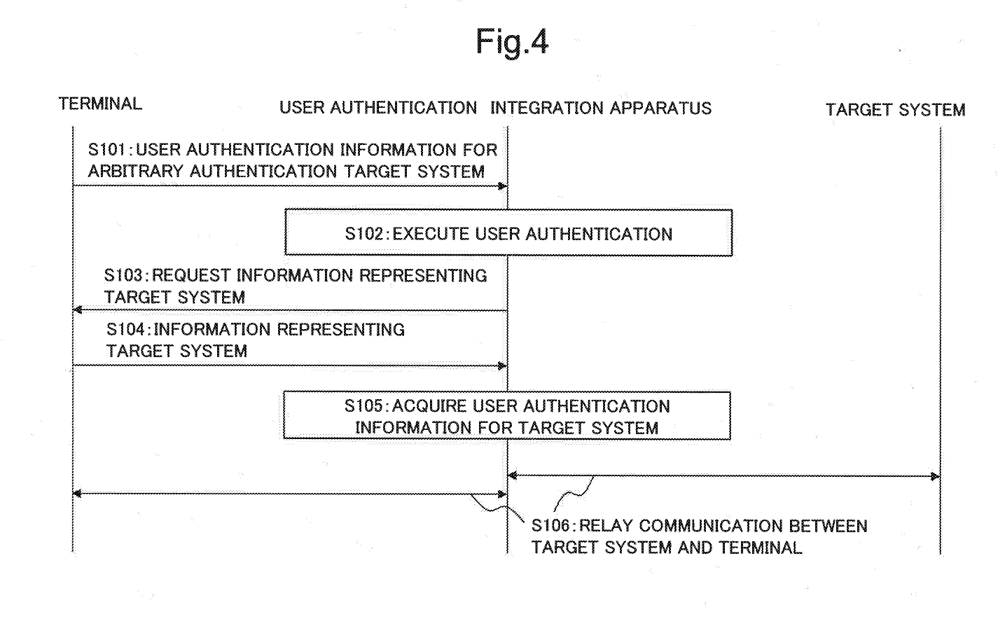

Next, FIG. 4 illustrates an example of operation when a terminal 92 uses a system 91 using the user authentication integration device 1 that operates as follows.

In FIG. 4, the terminal 92 first acquires user authentication information for an arbitrary authentication target system 91 through an input device or the like and transmits the user authentication information to the user authentication integration device 1 (step S101).

Next, in the user authentication integration device 1, the user authentication unit 12 performs user authentication relating to the authentication target system 91 using the received user authentication information (step S102). In this case, it is assumed that the user authentication is successful.

When the user authentication is successful, in the user authentication integration device 1, the target system acquisition unit 13 requests information representing a target system 91 from the terminal 92 (step S103).

Next, the terminal 92 acquires information representing the target system 91 through an input device or the like and transmits the information to the user authentication integration device 1 (step S104).

Next, in the user authentication integration device 1, the relay unit 14 acquires user authentication information for the target system 91, with regard to the user authorized at step S102, from the user authentication information management unit 11 (step S105).

Then, the relay unit 14 of the user authentication integration device 1 relays communication between the target system 91 and the terminal 92 (step S106).

The example of the flow of the operation when a terminal 92 uses a system 91 has been described.

The following will describe the effect of the first example embodiment of the present invention.

The user authentication integration device according to the first example embodiment of the present invention can facilitate use of a plurality of systems that each require user authentication without setting new user authentication information.

This is because of the following reason. According to the present example embodiment, the user authentication information management unit stores and manages, for each user, user authentication information for using each of one or more available systems. The user authentication unit receives user authentication information for an arbitrary authentication target system among the one or more systems from a terminal. The user authentication unit performs user authentication for the authentication target system using the received user authentication information. Then, when the user authentication is successful, the target system acquisition unit acquires, from the terminal, information representing a target system among the one or more systems. Then, the relay unit relays communication between the terminal and the target system using the user authentication information for the target system stored in the user authentication information management unit, with regard to the user authenticated by the user authentication unit.

In this way, a user can use a target system only by inputting user authentication information for an arbitrary system instead of user authentication information for the target system. Thus, a user can use one or more systems using any existing user authentication information without the need of creating new user authentication information for access, which improves convenience.

Furthermore, in the present example embodiment, even if a failure occurs in a user authentication function of a target system, communication between the target system and the terminal can be relayed, as long as user authentication using user authentication information for another system is successful. As such, the present example embodiment further improves user convenience.

### Second Example Embodiment

The following will describe the details of a second example embodiment of the present invention with reference to the drawings. Note that, in each drawing that is referred to in the description of the present example embodiment, the same components and the similar steps of operation as those of the first example embodiment of the present invention are indicated by the same signs, thereby omitting the detailed description thereof with regard to the present example embodiment.

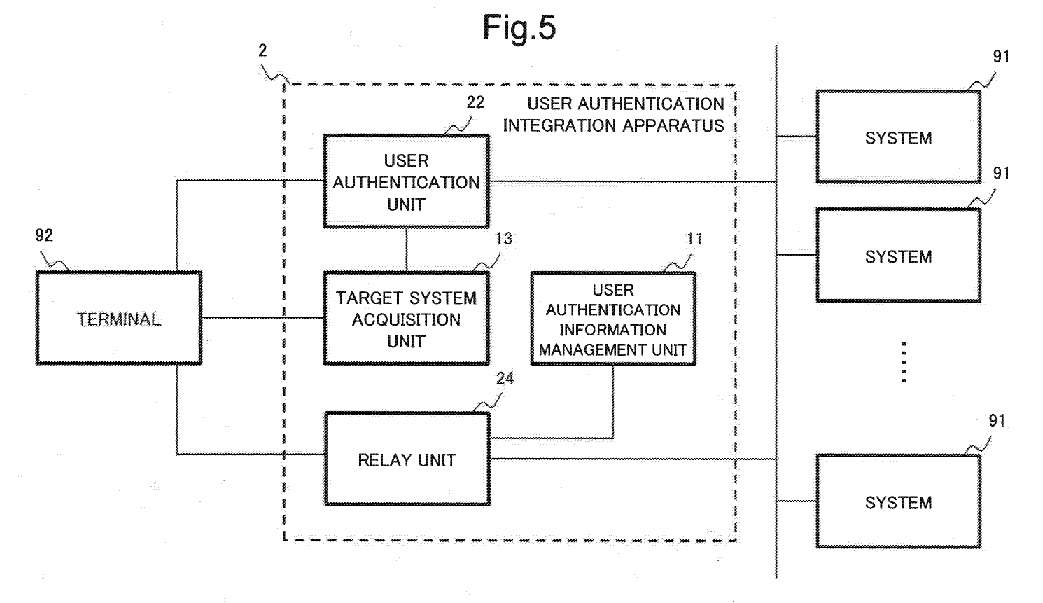

FIG. 5 illustrates a functional block view illustrating a configuration of a user authentication integration device 2 according to the second example embodiment of the present invention. In FIG. 5, the user authentication integration device 2 differs from the user authentication integration device 1 of the first example embodiment of the present invention in that the user authentication integration device 2 includes a user authentication unit 22 instead of the user authentication unit 12 and a relay unit 24 instead of the relay unit 14.

Note that the user authentication integration device 2 and the functional blocks thereof are configurable with similar hardware components as those of the first example embodiment of the present invention that has been described with reference to FIG. 2. However, the hardware configuration of the user authentication integration device 2 and the functional blocks is not limited to the above-described configuration.

Next, the details of each functional block will be described.

Although the user authentication unit 22 is configured generally in the same way as the user authentication unit 12 of the first example embodiment of the present invention, they differ in the following point. That is, the user authentication unit 22 transmits user authentication information received from a terminal 92 to an authentication target system 91 instead of collating the user authentication information with information stored in the user authentication information management unit 11. Then, the user authentication unit 22 receives information representing whether the user authentication is successful or not from the authentication target system 91.

Although the relay unit 24 is configured generally in the same way as the relay unit 14 of the first example embodiment of the present invention, they differ in the following point. That is, the relay unit 24 transmits the user authentication information to the target system 91 before relaying communication using the user authentication information for the target system 91 that can be acquired from the user authentication information management unit 11. Then, the relay unit 24 relays communication between the terminal 92 and the target system 91 when receiving information representing whether user authentication is successful from the target system 91.

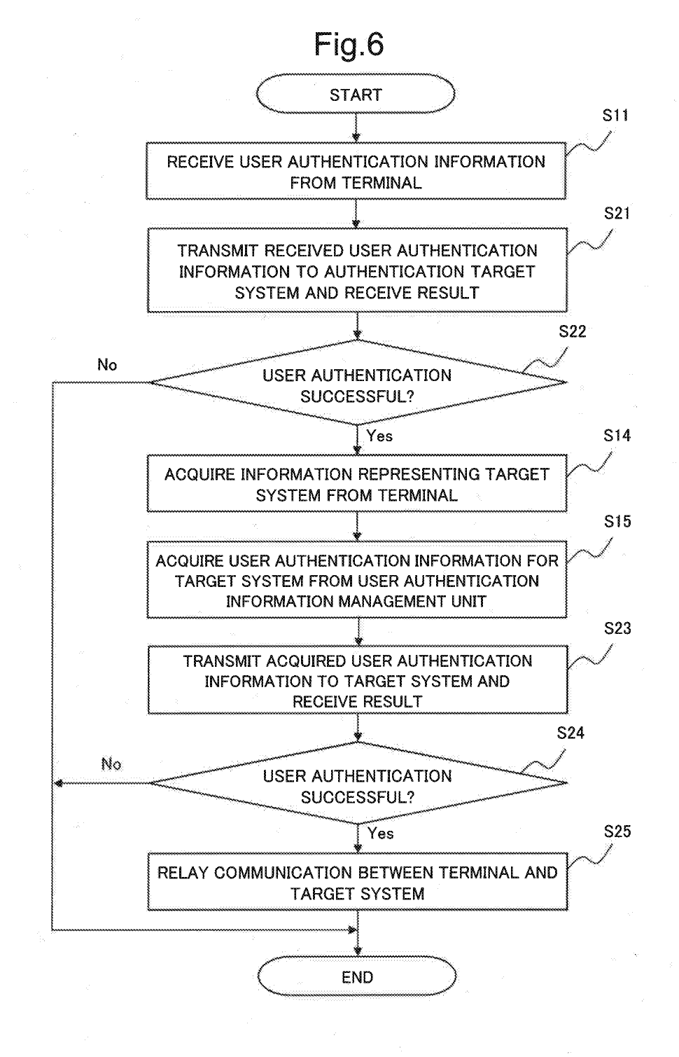

The operation of the user authentication integration device 2 with the above-described configuration will be described with reference to the drawings. First of all, the operation of the user authentication integration device 2 is illustrated in FIG. 6.

In FIG. 6, first, the user authentication unit 22 performs step S11 in the same way as the first example embodiment of the present invention, and receives information for identifying an arbitrary authentication target system 91 and user authentication information for the system 91 from the terminal 92.

Next, the user authentication unit 22 transmits the user authentication information received at step S11 to the authentication target system 91, and receives information representing whether the user authentication is successful (step S21).

Then, based on the information received from the authentication target system 91, the user authentication unit 22 determines whether the user authentication is successful (step S22).

When the user authentication unit 22 determines that the user authentication is not successful, the user authentication integration device 2 ends the processing.

Whereas, when a notification of successful user authentication determination is received from the user authentication unit 22, the target system acquisition unit 13 performs step S14 in the same way as in the first example embodiment of the present invention. That is, the target system acquisition unit 13 acquires information representing a target system 91 from the terminal 92.

Next, the relay unit 24 performs step S15 in the same way as in the first example embodiment of the present invention. That is, with regard to the user whose user authentication was determined as successful at step S22, the relay unit 24 acquires user authentication information for the target system 91 from the user authentication information management unit 11.

Next, the relay unit 24 transmits the acquired user authentication information to the target system 91 and receives information representing whether the user authentication is successful (step S23).

Then, based on the information received from the target system 91, the relay unit 24 determines whether the user authentication is successful (step S24).

When the relay unit 24 determines that the user authentication is not successful, the user authentication integration device 2 ends the processing.

Whereas, when the user authentication is determined as successful, the relay unit 24 relays communication between the terminal 92 and the target system 91 (step S25).

The operation of the user authentication integration device 2 has been described.

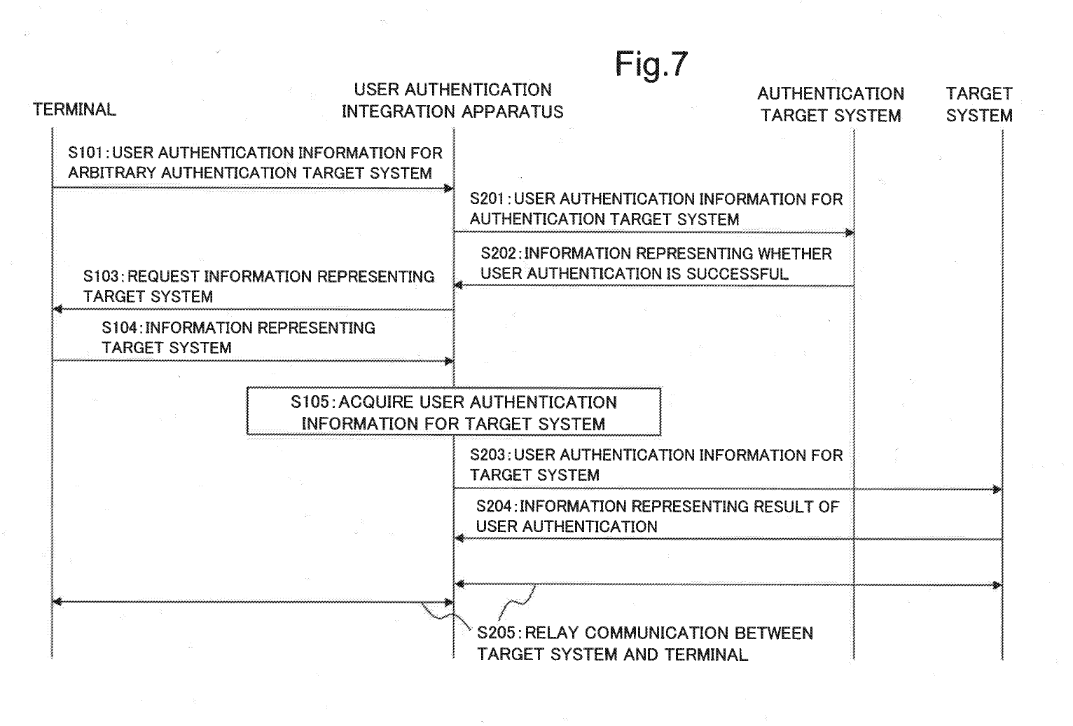

Next, FIG. 7 illustrates an example of operation when a terminal 92 uses systems 91 using the user authentication integration device 2 that operates as follows.

In FIG. 7, first, in the same way as in the first example embodiment of the present invention, the terminal 92 acquires user authentication information for an arbitrary system 91 through an input device or the like and transmits the user authentication information to the user authentication integration device 2 (step S101).

Next, in the user authentication integration device 2, the user authentication unit 22 transmits the received user authentication information to the authentication target system 91 (step S201).

Next, the authentication target system 91 performs user authentication using the transmitted user authentication information and transmits information representing whether the user authentication is successful to the user authentication integration device 2 (step S202). In this case, it is assumed that user authentication is successful.

When receiving the information representing successful user authentication, the target system acquisition unit 13 of the user authentication integration device 2 requests information representing a target system 91 from the terminal 92 in the same way as in the first example embodiment of the present invention (step S103).

Next, in the same way as in the first example embodiment of the present invention, the terminal 92 acquires information representing the target system 91 through an input device or the like and transmits the information to the user authentication integration device 2 (step S104).

Next, in the user authentication integration device 2, in the same way as the first example embodiment of the present invention, the relay unit 24 acquires, with regard to the user authenticated at step S202, user authentication information for the target system 91 from the user authentication information management unit 11 (step S105).

Then, the relay unit 24 of in the user authentication integration device 2 transmits the acquired user authentication information to the target system 91 (step S203).

Next, the target system 91 performs user authentication using the transmitted user authentication information and transmits information representing whether the user authentication is successful to the user authentication integration device 2 (step S204).

When receiving the information representing successful user authentication, the relay unit 24 of the user authentication integration device 2 relays communication between the target system 91 and the terminal 92 (step S205).

The example of the flow of the operation when a terminal 92 uses systems 91 has been described.

The following will describe the effect of the second example embodiment of the present invention.

The user authentication integration device according to the second example embodiment of the present invention can provide an effect of further facilitating use of a plurality of systems that each require user authentication without modifying the systems that provide services nor setting new user authentication information.

This is because of the following reason. In the present example embodiment, the user authentication unit transmits user authentication information that was received from a terminal to an authentication target system. Then, when receiving information representing successful user authentication from the authentication target system, the target system acquisition unit acquires information representing a target system from the terminal. With regard to the user authenticated by the user authentication unit, the relay unit transmits user authentication information for the target system, which is stored in the user authentication information management unit, to the target system. Then, when receiving information representing successful user authentication from the target system, the relay unit relays communication between the terminal and the target system.

In this way, in the present example embodiment, a user authentication request for a system providing a service is performed as a proxy for a terminal, using user authentication information received from the terminal or user authentication information stored in the user authentication information storage unit. As such, even if modification of an arbitrary system providing a service is difficult, a user can use the system, using any piece of existing user authentication information without the need of setting new user authentication information for access, according to the present example embodiment.

### Third Example Embodiment

The following will describe the details of a third example embodiment of the present invention with reference to the drawings. Note that, in each drawing that is referred to in the description of the present example embodiment, the same components and the similar steps of operation as those of the first example embodiment of the present invention are indicated by the same signs, thereby omitting the detailed description thereof with regard to the present example embodiment.

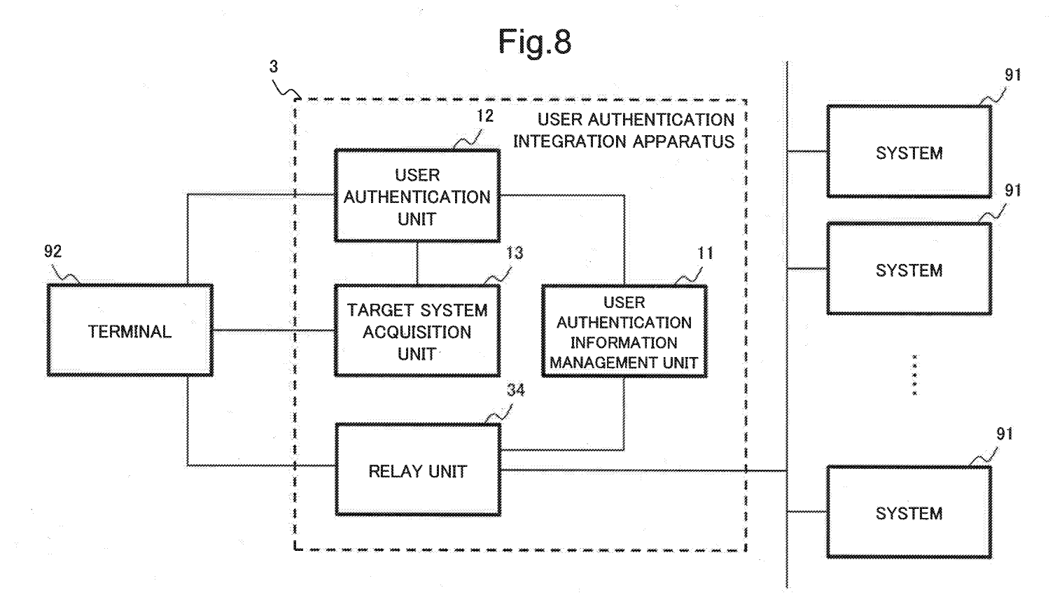

First of all, FIG. 8 illustrates a functional block view illustrating a configuration of a user authentication integration device 3 according to the third example embodiment of the present invention. In FIG. 8, the user authentication integration device 3 differs from the user authentication integration device 1 of the first example embodiment of the present invention in that the user authentication integration device 3 includes a relay unit 34 instead of the relay unit 14.

Note that the user authentication integration device 3 and the functional blocks thereof are configurable with similar hardware components as those of the first example embodiment of the present invention that has been described with reference to FIG. 2. However, the hardware configuration of the user authentication integration device 3 and the functional blocks is not limited to the above-described configuration.

Next, the details of each functional block will be described.

In addition to the like components as those of the first example embodiment of the present invention, the relay unit 34 also includes the following component. That is, in a communication that is relayed between the terminal 92 and the target system 91, the relay unit 34 detects update processing of user information that is used in the target system 91. The user information is information relating to a user. For example, user information may be personal information such as user name, attribute, or address.

Further, based on the user information in the detected update processing, the relay unit 34 transmits information requesting update of user information used in each of the other systems 91 to each of the other systems 91. At this time, the relay unit 34 may request update of user information using user authentication information for the rest of each of the other systems 91, which is stored in association with the user in the user authentication information management unit 11.

For example, it is assumed that systems 91 provide services on web pages. In such a case, the relay unit 34 can detect or request update processing of user information by storing, for all the systems 91, the uniform resource identifier (URI) of a web page of which user information can be updated and a URI of which processing is requested to be updated. However, other known techniques may instead be applied to detection and request of update processing of user information.

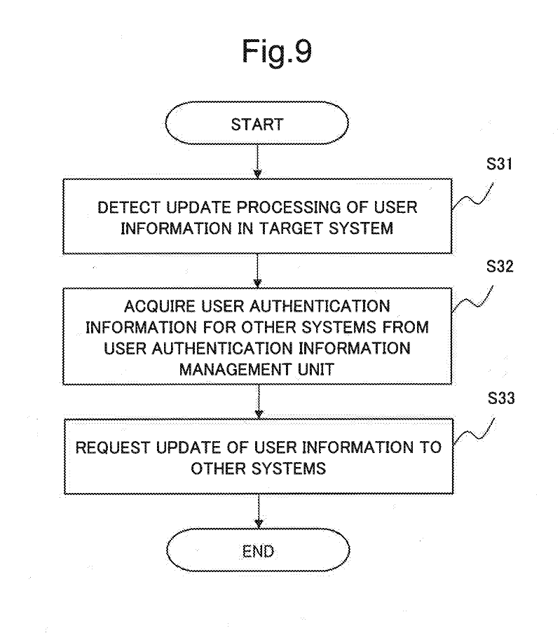

The operation of the user authentication integration device 3 with the above-described configuration will be described with reference to the drawings. First of all, the operation of the user authentication integration device 3 is illustrated in FIG. 9. This operation is performed while the relay unit 34 is relaying communication between a terminal 92 and a system 91. Hereinafter, a system 91 of which communication is being relayed is also referred to as the system 91 in use. Likewise, a user who is authenticated for the communication being relayed is also referred to as the user during use.

In FIG. 9, first, the relay unit 34 detects, in the communication it relays, update processing of user information in the system 91 in use (step S31).

Next, with regard to the user during use, the relay unit 34 acquires user authentication information for each of the other systems 91 from the user authentication information management unit 11 (step S32).

Then, based on the user information in the detected update processing, the relay unit 34 transmits information of requesting update of user information to each of the other systems 91, using the user authentication information acquired at step S32 (step S33).

The operation of the user authentication integration device 3 has been described.

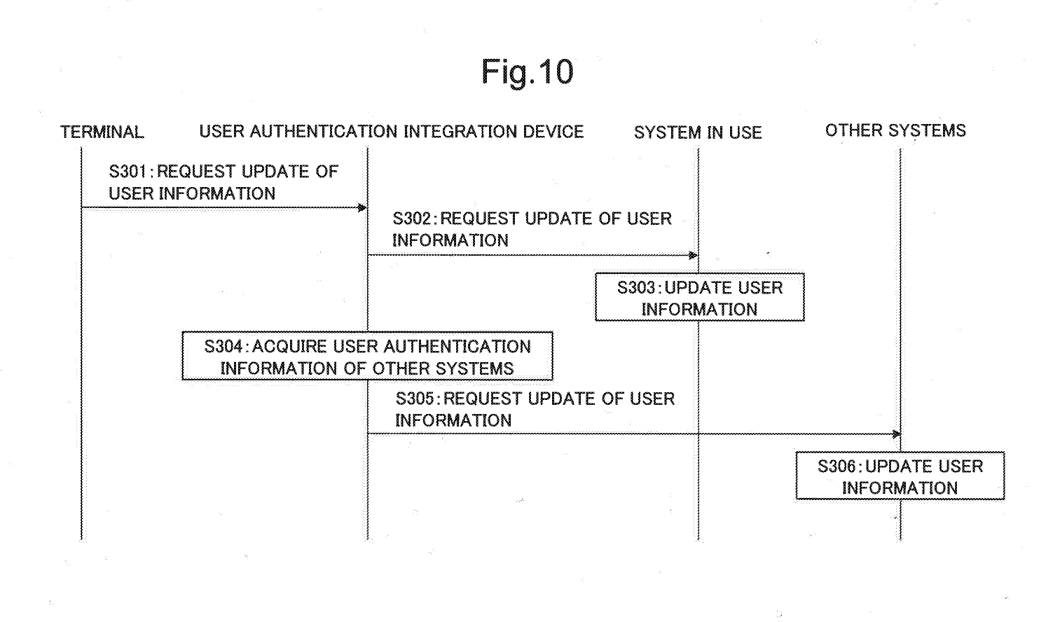

Next, FIG. 10 illustrates an example of operation when a terminal 92 uses systems 91 using the user authentication integration device 3 that operates as follows.

In FIG. 10, first, the terminal 92 transmits information of requesting update of user information of the system 91 in use to the user authentication integration device 3 (step S301).

Next, in the user authentication integration device 3, the relay unit 34 transmits the information of requesting update of user information, which was received from the terminal 92, to the system 91 in use (step S302).

Next, the target system 91 updates user information, based on the received information (step S303).

In addition, since the update processing of the user information is detected, the relay unit 34 of the user authentication integration device 3 acquires, with regard to the user during use, the user authentication information for each of the other systems 91 from the user authentication information management unit 11 (step S304).

Next, based on the user information in the detected update processing, the relay unit 34 of the user authentication integration device 3 transmits information of requesting update of user information to each of the other systems 91, using the respective user authentication information (step S305).

Next, each of the other systems 91 updates user information, based on the received information (step S306).

The example of the flow of the operation when a terminal 92 uses systems 91 has been described.

The following will describe the effect of the third example embodiment of the present invention.

The user authentication integration device according to the third example embodiment of the present invention facilitates use of a plurality of systems that each require user authentication without setting new user authentication information, and further facilitates update of user information for each of the systems.

This is because of the following reason. In the third example embodiment, in addition to the like components as those of the first example embodiment of the present invention, the relay unit detects, in communication that is relayed between a terminal and a system, update of user information used in the system. Then, based on the detected user information, the relay unit transmits information of requesting update of user information used in each of the other system to each of the other system. Further, the relay unit requests update of user information using user authentication information for each of the other systems stored in the user authentication information management unit with regard to the user.

As such, convenience is further improved in the third example embodiment, since user authentication for a plurality of systems is facilitated and user information is shared among the systems.

Note that, in each of the above-described example embodiments of the present invention, the user authentication information management unit may store, for each user, information representing systems that are available for the user. In such a case, the target system acquisition unit first acquires information representing a list of systems that are available for the user who has been authenticated by the user authentication unit from the user authentication information management unit, and outputs the acquired information representing the list to the terminal in a selectable manner.

Further, in each of the above-described example embodiments of the present invention, an example where user authentication information is information of a combination of an ID and a password has been described. However, the user authentication information is not limited to the ID and password. For example, the user authentication information may be information necessary for biometric authentication, such as fingerprint authentication, iris authentication, and face authentication.

Further, in each of the above-described example embodiments of the present invention, an example where user authentication information that is acquired by a terminal is information that is input through an input device to the terminal has been mainly described. However, the user authentication information is not limited to information that is input through the input device. For example, the user authentication information may be information that is stored in a portable recording medium that can be connected to the terminal. In such a case, when such a portable recording medium is connected, the terminal may be able to transmit the user authentication information stored in the portable recording medium to the user authentication integration device of the present example embodiment.

Further, in each of the above described example embodiments of the present invention, an example where the functional blocks of the user authentication integration device are implemented by a CPU that executes a computer program stored in a memory has been mainly described. Without limitation to this, a part or all functional blocks or a combination thereof may be implemented by dedicated hardware.

Alternatively, in each of the above-described example embodiments of the present invention, the functional blocks of the user authentication integration device may be implemented in a dispersed plurality of devices.

In the above-described example embodiments of the present invention, the operation of the user authentication integration device, which has been described with reference to each flowchart, may be stored in a storage device (a recording medium) of a computer device, as a computer program of the present invention. Then, the computer program may be read and executed by the CPU. In such a case, the present invention includes such a computer program code or a recording medium.

The above-described example embodiments may be implemented in combination as necessary.

Further, the present invention can be implemented by a variety of embodiments that can be understood by those skilled in the art within the scope of the claimed invention without limitation to the above-described example embodiments.

This application claims priority based on Japanese Patent Application No. 2016-121772 filed on Jun. 20, 2016, which application is incorporated herein in its entirety by disclosure.

### REFERENCE SIGNS LIST

1, 2, 3 User authentication integration device
11 User authentication information management unit
12, 22 User authentication unit
13 Use target system acquisition unit
14, 24, 34 Relay unit
91 System
92 Terminal
1001 CPU
1002 Memory
1005 Network interface

1. A user authentication integration device comprising:
an user authentication information management configured to store and manage, for each user, user authentication information for using each of one or more available systems;
an user authentication configured to, when receiving user authentication information for an arbitrary authentication target system among the systems from a terminal, performs user authentication relating to the authentication target system, using the received user authentication information;
a target system acquisition configured to, when the user authentication is successful, acquire, from the terminal, information representing a target system among the systems; and
a relay configured to relay communication between the terminal and the target system using user authentication information for the target system stored in the user authentication information management unit with regard to a user authenticated by the user authentication unit.

2. The user authentication integration device according to claim 1, wherein the user authentication unit performs the user authentication by collating the received user authentication information with information stored in the user authentication information management unit.

3. The user authentication integration device according to claim 1, wherein the user authentication unit performs the user authentication by transmitting the received user authentication information to the authentication target system and receiving information representing whether the user authentication is successful from the authentication target system.

4. The user authentication integration device according to claim 1, wherein the relay unit relays communication between the terminal and the target system, when the relay unit transmits user authentication information for the target system, which is stored in the user authentication information management unit with regard to a user authorized by the user authentication unit, to the target system and receives information representing successful user authentication from the target system.

5. The user authentication integration device according to claim 1, wherein, when the user authentication information management unit stores and manages the user authentication information for each of a plurality of systems,
when the relay unit detects update processing of user information relating to the user, which is used in the system, in communication that the relay unit is relaying between the terminal and the system, the relay unit transmits, based on the user information in the detected update processing, information of requesting update of user information that is used in each of the other systems to each of the other systems, using the user authentication information for each of the other systems stored in the user authentication information management unit with regard to the user.

6. A method, using user authentication information management unit configured to store and manage, for each user, user authentication information for using each of one or more available systems,
the method comprising: by a computer device,
when receiving, from a terminal, user authentication information for an arbitrary authentication target system among the systems, performing user authentication relating to the authentication target system using received user authentication information;
when the user authentication is successful, acquiring, from the terminal, information representing a target system among the systems; and
relaying communication between the terminal and the target system using user authentication information for the target system stored in the user authentication information management unit with regard to an authenticated user.

7. A non-transitory computer readable recording medium for storing a program, using user authentication information management unit configured to store and manage, for each user, user authentication information for using each of one or more available systems, causing a computer device to perform:
when receiving user authentication information for an arbitrary authentication target system among the systems from a terminal, performing user authentication relating to the authentication target system using the received user authentication information;
when the user authentication is successful, acquiring, from the terminal, information representing a target system among the systems; and
relaying communication between the terminal and the target system using user authentication information for the target system stored in the user authentication information management means with regard to a user authenticated at the user authentication.

8. The user authentication integration device according claim 2, wherein the relay unit relays communication between the terminal and the target system, when the relay unit transmits user authentication information for the target system, which is stored in the user authentication information management unit with regard to a user authorized by the user authentication unit, to the target system and receives information representing successful user authentication from the target system.

9. The user authentication integration device according claim 3, wherein the relay unit relays communication between the terminal and the target system, when the relay unit transmits user authentication information for the target system, which is stored in the user authentication information management unit with regard to a user authorized by the user authentication unit, to the target system and receives information representing successful user authentication from the target system.

10. The user authentication integration device according to claim 2, wherein, when the user authentication information management unit stores and manages the user authentication information for each of a plurality of systems,
when the relay unit detects update processing of user information relating to the user, which is used in the system, in communication that the relay unit is relaying between the terminal and the system, the relay unit transmits, based on the user information in the detected update processing, information of requesting update of user information that is used in each of the other systems to each of the other systems, using the user authentication information for each of the other systems stored in the user authentication information management unit with regard to the user.

11. The user authentication integration device according to claim 3, wherein, when the user authentication information management unit stores and manages the user authentication information for each of a plurality of systems,
when the relay unit detects update processing of user information relating to the user, which is used in the system, in communication that the relay unit is relaying between the terminal and the system, the relay unit transmits, based on the user information in the detected update processing, information of requesting update of user information that is used in each of the other systems to each of the other systems, using the user authentication information for each of the other systems stored in the user authentication information management unit with regard to the user.

12. The user authentication integration device according to claim 4, wherein, when the user authentication information management unit stores and manages the user authentication information for each of a plurality of systems,
when the relay unit detects update processing of user information relating to the user, which is used in the system, in communication that the relay unit is relaying between the terminal and the system, the relay unit transmits, based on the user information in the detected update processing, information of requesting update of user information that is used in each of the other systems to each of the other systems, using the user authentication information for each of the other systems stored in the user authentication information management unit with regard to the user.
